(19) United States
(12) Patent Application Publication
(10) Pub. No.: US 2026/0161735 A1
(43) Pub. Date: Jun. 11, 2026

(54) ARTIFICIAL NEURAL NETWORK PROCESSOR, ACCELERATOR COMPRISING THEREOF AND MATRIX CALCULATION METHOD

(71) Applicant: ELECTRONICS AND TELECOMMUNICATIONS RESEARCH INSTITUTE, Daejeon (KR)

(72) Inventors: Jin Ho HAN, Daejeon (KR); Ju Yeob KIM, Daejeon (KR); Jin Kyu KIM, Daejeon (KR); Hyun Jeong KWON, Daejeon (KR); Jae Hoon CHUNG, Daejeon (KR); Yong Cheol CHO, Daejeon (KR); Jae Woong CHOI, Daejeon (KR)

(73) Assignee: ELECTRONICS AND TELECOMMUNICATIONS RESEARCH INSTITUTE, Daejeon (KR)

(21) Appl. No.: 19/378,472

(22) Filed: Nov. 4, 2025

(30) Foreign Application Priority Data
Dec. 10, 2024 (KR) 10-2024-0182521
Apr. 17, 2025 (KR) 10-2025-0050149

(51) Int. Cl. G06F 17/16

(52) U.S. Cl. CPC G06F 17/16

(57) ABSTRACT

The present disclosure relates to a processor for performing matrix operations, the processor comprising: a plurality of computation cores, wherein each of the computation cores comprises: a scalar processor array that performs the matrix operations; an X register that stores and provides a first operand of the matrix operations, a Y register that stores and provides a second operand of the matrix operations, and a result register that stores matrix operation results, wherein the first operand and the second operand are loaded to a plurality of scalar processors of the array to perform the matrix operations, and the scalar processor array performs cyclic shift of the loaded first operand and the second operand in one direction and another direction of the array, respectively. This configuration resolves bottlenecks occurring during data movement due to limited bandwidth and routing difficulties caused by numerous wirings for providing data to processors for computation, thereby enabling efficient artificial neural network processing with reduced wiring complexity and improved computational performance in large language model applications.

### CROSS-REFERENCE TO RELATED APPLICATIONS

This application claims priority to Korean Patent Application Nos. 10-2024-0182521, filed on Dec. 10, 2024 and 10-2025-0050149, filed on Apr. 17, 2025, the entire contents of which are hereby incorporated by reference.

### BACKGROUND

The present disclosure generally relates to an artificial neural network processor, an accelerator comprising thereof, and a matrix calculation method.

### DESCRIPTION OF THE RELATED ART

With the rapid growth of large language models, the data of parameters used for computation reaches several terabytes. Performing large language model computations using such large-capacity parameters involves many difficulties.

The demands for semiconductor performance and memory bandwidth to resolve these difficulties are increasing. To meet these demands, semiconductors are attempting to increase semiconductor performance and memory bandwidth using heterogeneous integration utilizing chiplets rather than a single die.

The bottleneck that occurs during data movement due to limited bandwidth and the routing difficulties caused by numerous wirings for providing data to processors for data computation arise.

The present disclosure aims to resolve these difficulties of the prior art.

### SUMMARY

According to one aspect, a processor for performing matrix operations comprises: a plurality of computation cores, wherein each of the computation cores comprises: a scalar processor array that performs the matrix operations; an X register that stores and provides a first operand of the matrix operations, a Y register that stores and provides a second operand of the matrix operations, and a result register that stores matrix operation results, wherein the first operand and the second operand are loaded to a plurality of scalar processors of the array to perform the matrix operations, and the scalar processor array performs cyclic shift of the loaded first operand and the second operand in one direction and another direction of the array, respectively.

According to one aspect of this embodiment, each of the scalar processors includes an operation unit that performs one or more of addition, subtraction, multiplication, and MAC (multiply and accumulate) operations, and registers that store the first operand and the second operand.

According to one aspect of this embodiment, the X register stores a multiplicand matrix that is a target of the matrix operations and outputs row-wise to the scalar processors included in any one column of the scalar processor array, and the Y operand register stores a multiplier matrix that is a target of the matrix operations and outputs column-wise to the scalar processors included in any one row of the scalar processor array. In this aspect, the scalar processors cyclically shift the output first operand along one direction of the array to load to each scalar processor, and cyclically shift the output second operand along another direction of the array to load to each scalar processor. In this aspect, in the array, the number of cyclic shifts performed by the scalar processors included in adjacent rows differs by one, and the number of cyclic shifts performed by the scalar processors included in adjacent columns differs by one.

According to one aspect of this embodiment, the scalar processors perform cyclic shift in one direction and another direction of the array after performing the matrix operations with the loaded first operand and the second operand.

According to one aspect of this embodiment, the X register provides the first operand to only any one column of the array, and the Y register provides the second operand to only any one row of the array.

According to one aspect of this embodiment, when the plurality of scalar processors perform the matrix operations with the shifted first operand and the second operand, operands to be computed in another computation core among the plurality of computation cores are fetched.

According to one aspect of this embodiment, each of the computation cores further comprises: an X multiplexer (MUX) that selects any one of the first operands provided by X registers included in the plurality of computation cores and outputs to the processor X register; and a Y multiplexer that outputs any one of the second operands provided by Y registers included in the plurality of computation cores and matrix operation results provided by accumulation registers included in the plurality of computation cores to the processor Y register.

According to one aspect of this embodiment, the value stored in the result register is provided as any one of the first operand and the second operand to one or more of the plurality of computation cores.

According to one aspect, an artificial intelligence computation accelerator comprises: a tensor processor including k computation cores; a high bandwidth memory; an internal memory unit including a cache memory that stores data to be computed from the high bandwidth memory and an instruction cache that stores instructions for the tensor processor; and a control unit that fetches data and instructions from the internal memory and provides them to the tensor processor, wherein the accelerator communicates data with the high bandwidth memory through a designated pseudo channel.

According to one aspect of this embodiment, the accelerator further comprises a bus structure that communicates with the high bandwidth memory and a plurality of the accelerators.

According to one aspect of this embodiment, the accelerator operates in a globally asynchronous locally synchronous manner and is capable of local power gating and clock gating.

According to one aspect of this embodiment, a plurality of the accelerators are included in one neural processing unit (NPU) die, and k neural processing units and j high bandwidth memory packages are bonded to an interposer to form a computation device (k, j: natural numbers).

According to this embodiment, a matrix operation method performed in a scalar processor array including an X register that stores a first operand of matrix operations, a Y register that stores a second operand, and a plurality of scalar processors, wherein the matrix operation method comprises: an operand providing step in which the X register provides the first operand to the array and the Y register provides the second operand to the array; an operation step in which the scalar processors included in the array perform the matrix operations with the provided first operand and second operand; and a step in which each of the scalar processors included in the array cyclically shifts the provided first operand in one direction of the array and cyclically shifts the second operand in another direction of the array.

According to one aspect of this embodiment, the first operand is a row of a multiplicand matrix and the second operand is a column of a multiplier matrix, and the operand providing step is performed by the X register providing elements of the first operand row along any one column of the scalar processor array and the Y register outputting elements of the second operand column along any one row of the scalar processor array. In this aspect, the matrix operation method further comprises a loading step performed after the operand providing step, in which the scalar processors cyclically shift the output first operand along rows of the array to load to respective scalar processors and cyclically shift the output second operand along columns of the array to load to respective scalar processors.

According to one aspect of this embodiment, in the operand providing step, the X register provides the first operand to only any one column of the array, and the Y register provides the second operand to only any one row of the array.

According to one aspect of this embodiment, after the matrix operation method is completed, the method further comprises a step in which the matrix operation result is provided as operands to one or more of a plurality of computation cores.

According to one aspect of this embodiment, when the matrix operation method is performed in a processor including a plurality of X registers, a plurality of Y registers, and a plurality of scalar processor arrays, when performing the matrix operation method in a computation core of one scalar processor array, one or more of the following are performed: a step of storing the first operand in the X register of another scalar processor array and a step of storing the second operand in the plurality of Y registers of the other scalar processor array.

### BRIEF DESCRIPTION OF THE DRAWINGS

FIG. 1 is a diagram schematically illustrating a neural network computation device including the processor of this embodiment.

FIG. 2 is a diagram illustrating an overview of the processor of this embodiment.

FIG. 3 is a diagram illustrating the connection relationship between a single NPU die, four HBM memories, and external host memory.

FIG. 4 is a diagram schematically illustrating the computation cores, load unit, and storage unit of this embodiment.

FIG. 5 is a flowchart schematically illustrating the operation method of the computation core of this embodiment.

FIG. 6 is a diagram for explaining the operand input process.

FIG. 7 is a diagram illustrating the scalar processor array cyclically shifting the first operand in one direction and the second operand in another direction.

FIG. 8 to FIG. 11 are diagrams illustrating the steps of performing cyclic shift and operations for each row and column in a 32×32 scalar processor array.

FIG. 12 is a diagram illustrating an embodiment of a computation core included in the processor.

### DETAILED DESCRIPTION OF THE EMBODIMENTS

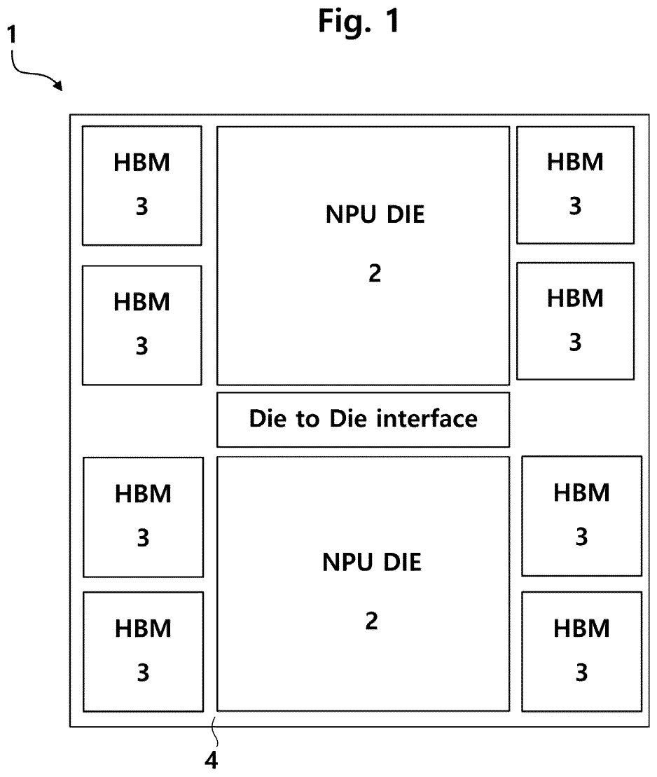

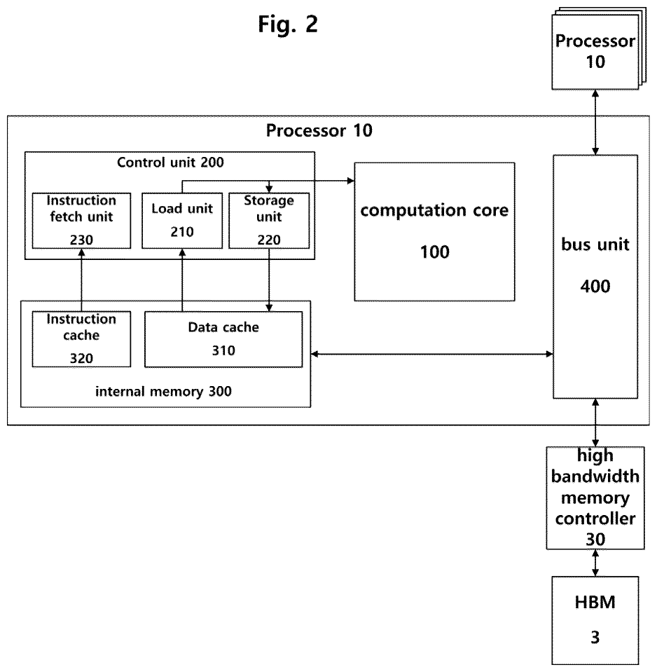

Hereinafter, this embodiment will be described with reference to the accompanying drawings. FIG. 1 is a diagram schematically illustrating a neural network computation device 1 including the processor 10 (see FIG. 2) of this embodiment. Referring to FIG. 1, the neural network computation device 1 includes a neural processing unit (NPU) die 2 and high bandwidth memory 3, connected through an interposer 4. In the computation device 1 of the illustrated embodiment, two NPU dies 2 and eight high bandwidth memories (HBM) 3 are connected through the interposer 4.

The interposer 4 enables connection between the NPU dies 2 and high bandwidth memory 3 and a substrate (not shown), can improve data transmission speed through dense wiring, reduce signal loss between high-performance semiconductor chips, and enable efficient communication.

In the embodiment illustrated in FIG. 1, one NPU die 2 can communicate with four HBMs 3 with a data width of 4096 bits. The high bandwidth memory (HBM) 3 has 16 64-bit channels, and each channel is divided into two 32-bit pseudo channels. Therefore, the high bandwidth memory 3 can expand a total of 16 physical channels into 32 pseudo channels. In the illustrated embodiment, one NPU die 2 includes 128 processors 10 (see FIG. 2) and performs communication with four high bandwidth memories 3, so each of the 128 processors 10 (see FIG. 2) can perform communication with the high bandwidth memory 2 through a dedicated pseudo channel.

The two NPU dies 2 communicate with the high bandwidth memory 3 within the computation device 1 with a maximum data width of 8192 bits. Also, die-to-die communication between NPU dies can be performed with a 1300-bit data width.

FIG. 2 is a diagram illustrating an overview of the processor 10 of this embodiment. Referring to FIG. 2, the processor 10 of this embodiment includes: a computation core 100 including a plurality of scalar processors; an internal memory 300 including a data cache 310 that stores data fetched from the high bandwidth memory 3 and an instruction cache 320 that stores instructions; and a control unit 200 that controls the processor 10. The processor 10 communicates data with the high bandwidth memory 3 through a designated pseudo channel via a bus unit 400. The control unit 200 may include a load unit 210, a storage unit 220, and an instruction fetch unit 230. The load unit 210 and the instruction fetch unit 230 may be implemented by another processor including hardware and/or a software module configured to perform corresponding functions described herein. The instruction fetch unit 230 may fetch instructions from the instruction cache 320, enabling the control unit 200 to operate based on the instructions.

In the embodiment illustrated in FIGS. 1 and 2, 128 ANC unit 4TFLOPS processors are integrated in one NPU die 2 to achieve performance of 512TFLOPS. Each die 2 further includes a high bandwidth memory controller 30 and a physical layer (not shown). The high bandwidth memory controller 30 controls the HBM 3 so that one NPU die 2 can simultaneously read four high bandwidth memories 3.

The processors 10 according to the illustrated embodiment are implemented in a globally asynchronous, locally synchronous (GALS) manner, and can control the clock frequency and power of elements included in each processor 10, enabling fine control of operating frequency and power control.

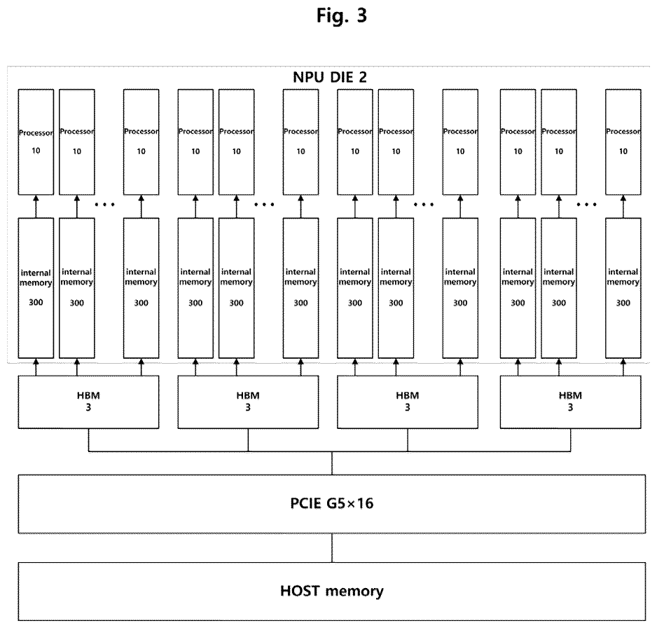

FIG. 3 is a diagram illustrating the connection relationship between a single NPU die 2, four HBM memories 3, and external host memory. Referring to FIG. 3, each processor 10 is connected to the high bandwidth memory 3 through a dedicated pseudo channel via the internal memory 300. Therefore, bottlenecks can be minimized to improve data transmission performance. The high bandwidth memory 3 can be connected to host memory through PCIE G5×16 lanes.

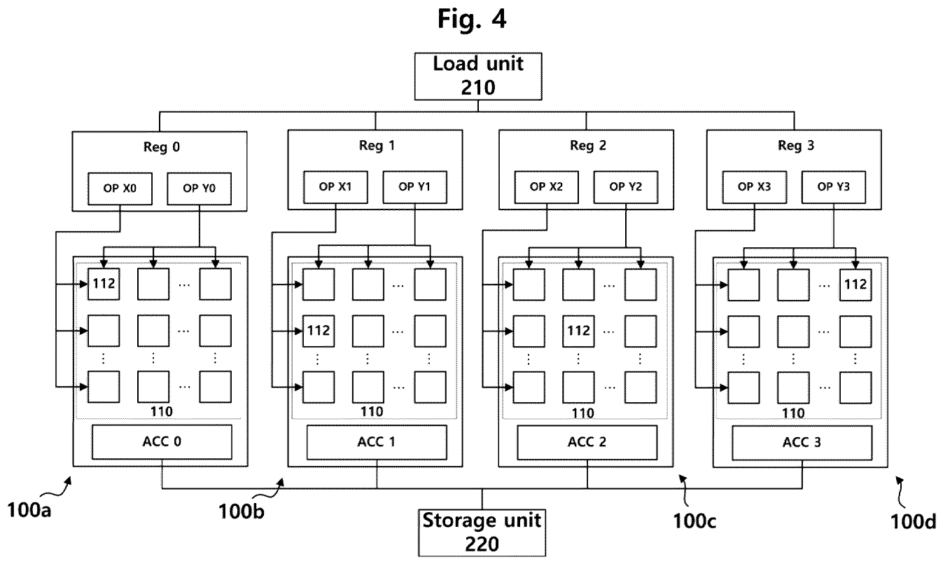

FIG. 4 is a diagram schematically illustrating the computation cores 100a, 100b, 100c, 100d, the load unit 210, and the storage unit 220 of this embodiment. Referring to FIG. 4, as a processor 10 that performs matrix operations, the processor 10 includes: a plurality of computation cores 100, wherein each computation core 100a, 100b, 100c, 100d includes: a scalar processor array 110 that performs matrix operations; X registers (OP X0, OP X1, OP X2, OP X3) that store and provide first operands of matrix operations, Y registers (OP Y0, OP Y1, OP Y2, OP Y3) that store and provide second operands of matrix operations, and result registers (ACC 0, ACC 1, ACC 2, ACC 3) that store matrix operation results.

Matrix operations are performed by loading the first operand and second operand to a plurality of scalar processors 112 included in the array 110, and the scalar processor array 110 performs cyclic shift of the loaded first operand and second operand in one direction and another direction of the array 110, respectively.

Each scalar processor 112 may be a fused multiplication adder (FMA) that multiplies provided operands and accumulates multiplication results. Also, the scalar processor 112 may include an operation unit that performs multiplication, addition, subtraction, and MAC operations on input operands, a row element register that stores elements of the provided first operand, and a column element register that stores elements of the second operand. The row element register and column element register can provide operands to scalar processors 112 adjacent in the row and column directions of the array. Therefore, operands are shifted along the row and column directions of the array. Also, the scalar processor 112 may include an accumulation register that stores results of operations performed with input operands, and the accumulation register may be connected to a result register (ACC) to provide operation results to the result register.

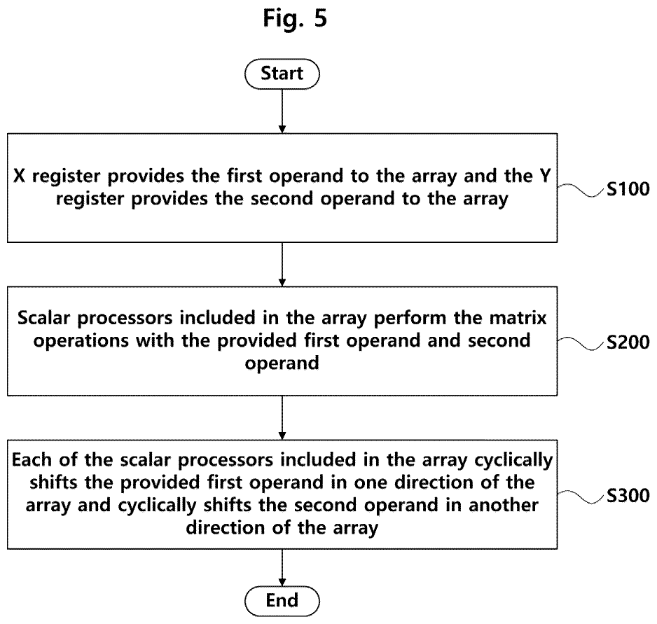

FIG. 5 is a flowchart schematically illustrating an operation method of the computation core 100 of this embodiment. Referring to FIG. 5, a matrix operation method performed in a scalar processor array 110 including an X register that stores a first operand of matrix operations, a Y register that stores a second operand, and a plurality of scalar processors 112 comprises: an operand providing step S100 in which the X register provides the first operand to the array and the Y register provides the second operand to the array; an operation step S20S in which the scalar processor 112 included in the array 110 performs matrix operations with the provided first operand and second operand; and a step S30S in which each of the scalar processors 112 included in the array 110 cyclically shifts the provided first operand in one direction of the array and cyclically shifts the second operand in another direction of the array. In one embodiment, the operation step S20S and cyclic shift step S30S may be repeatedly performed until the matrix operation is completed.

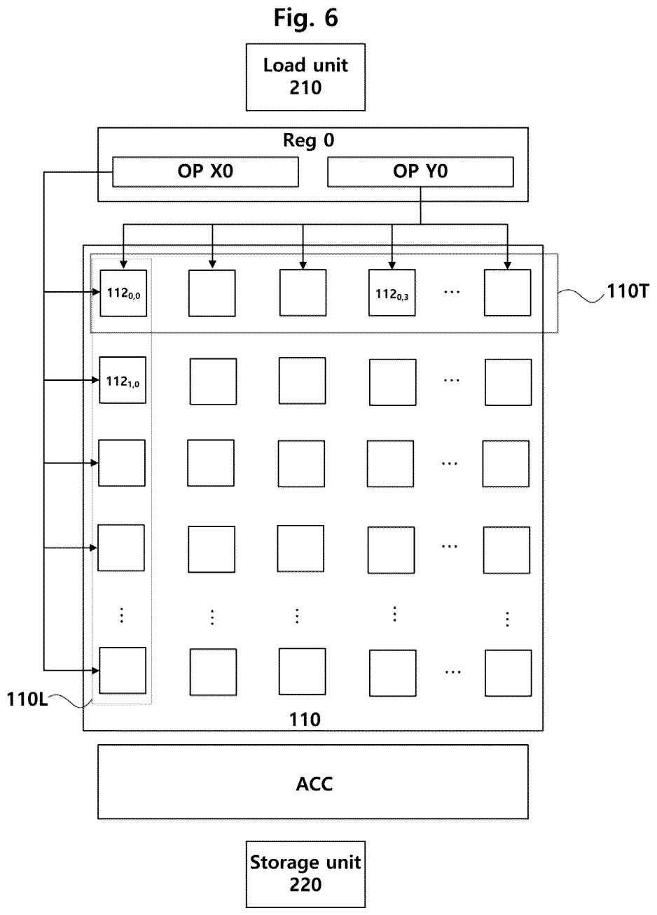

FIGS. 6 to 9 are diagrams for explaining the process of computing matrix multiplication according to the following mathematical equation. In the illustrated embodiment, multiplicand matrix A is a 32×32 matrix, and multiplier matrix B is a 32×32 matrix. In the example shown below, the scalar processor array 110 includes scalar processors 112 arranged in a 32×32 array. However, the number of scalar processors is purely for explanatory purposes and is not intended to limit the present invention.

### [Mathematical Equation 1]

$$A \times B = [ \begin{matrix}{a}_{0 , 0} & {a}_{0 , 1} & {a}_{0 , 2} & … & {a}_{0 , 31} \\ {a}_{1 , 0} & {a}_{1 , 1} & {a}_{1 , 2} & … & {a}_{1 , 31} \\ {a}_{2 , 0} & {a}_{2 , 1} & {a}_{2 , 2} & … & {a}_{2 , 31} \\ … & … & … & … & … \\ {a}_{31 , 0} & {a}_{31 , 1} & {a}_{31 , 2} & … & {a}_{31 , 31}\end{matrix} ] [ \begin{matrix}{b}_{0 , 0} & {b}_{0 , 1} & {b}_{0 , 2} & … & {b}_{0 , 31} \\ {b}_{1 , 0} & {b}_{1 , 1} & {b}_{1 , 2} & … & {b}_{1 , 31} \\ {b}_{2 , 0} & {b}_{2 , 1} & {b}_{2 , 2} & … & {b}_{2 , 31} \\ … & … & … & … & … \\ {b}_{31 , 0} & {b}_{31 , 1} & {b}_{31 , 2} & … & {b}_{31 , 31}\end{matrix} ] .$$

The load unit 210 reads multiplicand matrix A, which is the first operand of matrix multiplication, and multiplier matrix B, which is the second operand, that the control unit 200 fetched from the high bandwidth memory 3 and loaded into the data cache 310, and loads them into the X0 register that stores the first operand and the Y0 register that stores the second operand, respectively. As will be described later, the load unit 210 can read one or more of multiplicand matrix A and multiplier matrix B data stored in the high bandwidth memory 3 while performing matrix operations in one or more of the other computation cores 100a, 100b, 100c, 100d, store them in the data cache 310 of the internal memory 300, and load them into the X0 register and/or Y0 register.

For matrix multiplication operations, the X0 register provides elements row-wise of the first operand to any one column of the array 1110 of the plurality of scalar processors 112. Also, the Y0 register provides elements column-wise of the second operand to any one row of the plurality of scalar processors 110 arranged in an array S100.

In one embodiment, the X0 register may be connected to any column of the array formed by the scalar processors 110 to provide row elements of the first operand. Also, the Y0 register may be connected to any one row of the array formed by the scalar processors 110 to provide column elements of the second operand.

In the illustrated embodiment, for easy understanding, the X0 register outputs row elements of the first operand to the leftmost column 110L of the array 110 formed by the scalar processors 112, and the Y0 register outputs column elements of the first operand to the topmost row 110T of the array 110 formed by the scalar processors 112. However, this is not intended to limit the present invention but for easy understanding.

Continuing to refer to FIG. 6, the X0 register outputs elements row-wise of the first operand to the scalar processors included in the leftmost column 110L of the array. In one embodiment, elements a_{0,31}, a_{0,30}, a_{0,29}, . . . , a_{0,0} of row 0 of the first operand may be provided in this order to the scalar processor 112_{0,0} located in row 0 of the leftmost column 110L, and the scalar processor 112_{0,0} that received the elements can shift and provide the provided elements to adjacent scalar processors along the row direction of the array. Therefore, a_{0,31} provided first is continuously shifted and stored in the register of the scalar processor located in the rightmost column of the array 110. Through this process, row element data a_{0,0}, a_{0,1}, a_{0,2}, . . . , a_{0,31} is stored from left to right in the registers of the scalar processors of the topmost row 110T of the array 110.

Similarly, elements a_{2,31}, a_{2,30}, a_{2,29}, . . . , a_{2,0} of row 2 of the first operand may be provided in this order from left to right to the scalar processor 112_{2,0} located in row 2. The scalar processors that received the elements shift and provide the provided elements to adjacent scalar processors along the rows of the array. Therefore, a_{2,0} provided last is stored in the row element register of the scalar processor located in the leftmost column of the array 110.

The Y0 register outputs elements column-wise of the second operand to the scalar processors included in the topmost row 110T of the array. In one embodiment, elements b_{31,0}, b_{30,0}, b_{29,0}, . . . , b_{0,0} of column 0 of the second operand may be provided in this order to the scalar processor 112_{0,0} located in column 0. The scalar processor 112_{0,0} that received the elements can shift and provide the provided elements to adjacent scalar processors along the column of the array. Therefore, b_{31,0} provided first is continuously shifted and stored in the register of the scalar processor located in the bottom column of the array 110. Through this process, column element data b_{31,0}, b_{30,0}, b_{29,0}, . . . , b_{0,0} is stored from bottom to top in the registers of the scalar processors of the leftmost column 110L of the array 110.

Similarly, elements b_{31,3}, b_{30,3}, b_{23,3}, . . . , b_{0,3} of column 3 of the second operand may be provided in this order to the scalar processor 112_{0,3} located in column 3. The scalar processors that received the elements shift and provide the provided elements to adjacent scalar processors along the columns of the array. Therefore, b_{1,3} provided second to last is stored in the column element register of the scalar processor 112_{1,3} located just below the topmost column. In this way, by shifting and inputting computation target data to the scalar processors included in the array, the advantage of reducing wiring difficulties is provided.

As described above, the column element registers included in the scalar processors can be connected to shift with each other within the same column, and the first register and last register of a column can be connected to each other to perform cyclic shift. Also, the row element registers included in the scalar processors can be connected to shift with each other within the same row. The start end register and end end register of a row can be connected to each other to perform cyclic shift.

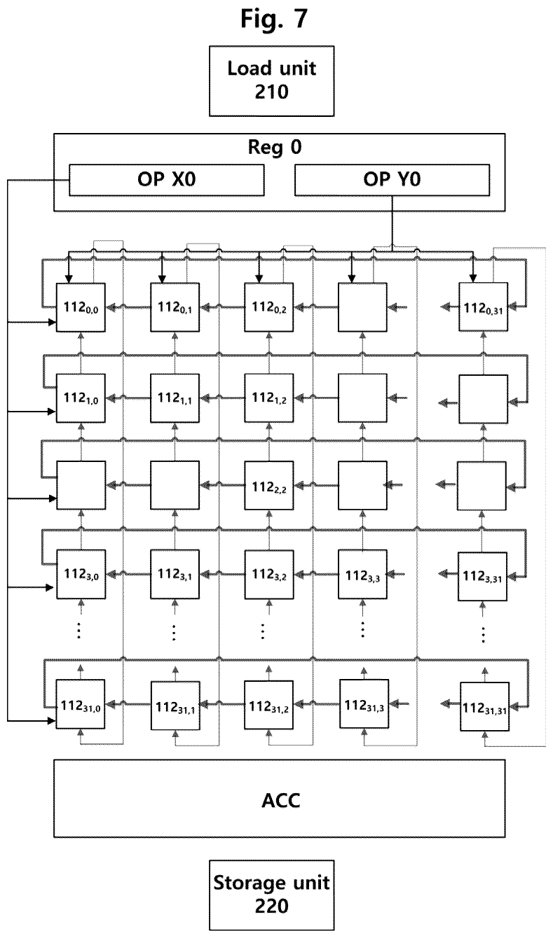

As illustrated in FIG. 7, the scalar processor array 110 cyclically shifts the first operand provided by the X register in one direction and cyclically shifts the second operand provided by the Y register in another direction. In one embodiment, the scalar processors located in row n of the array 110 each cyclically shift the provided first operand n times in one direction and output (n: positive integer including 0). Therefore, the row element registers of the scalar processors located in row n are provided with the first operand cyclically shifted n times in one direction and load their respective values.

For example, the scalar processors 112_{0,0}, 112_{0,1}, . . . , 112_{0,31} located in row 0 of the array 110 cyclically shift the row elements of the first operand 0 times in one direction. Therefore, the scalar processors located in row 0 do not perform cyclic shift.

As another example, the scalar processors 112_{3,0}, 112_{3,1}, . . . , 112_{3,31} located in row 3 of the array 110 cyclically shift the first operand 3 times in one direction. Therefore, cyclic shift is performed 3 times for the scalar processor 112_{3,0} located in row 3 of the array 110. Therefore, the first operand row element value that was stored in the scalar processor 112_{3,3} is cyclically shifted 3 times and provided to the scalar processor 112_{3,0} and loaded into the row element register. The first operand row element value that was stored in the scalar processor 112_{3,0} is cyclically shifted 3 times and provided to the scalar processor 112_{3,29} and loaded into the row element register.

In one embodiment, the scalar processors located in column k of the array 110 cyclically shift the second operand k times in another direction (k: positive integer including 0). For example, the scalar processors located in column 0 of the array 110 cyclically shift the second operand 0 times in another direction. Therefore, the scalar processors located in column 0 of the array 110 do not cyclically shift the second operand.

As another example, the scalar processors 112_{0,2}, 112_{1,2}, . . . , 112_{31,2} located in column 2 of the array 110 cyclically shift the second operand 2 times in another direction. Therefore, the second operand column element value that was stored in the scalar processor 112_{2,2} is cyclically shifted 2 times and provided to the scalar processor 112_{0,2} and loaded into the column element register. Similarly, the second operand row element value that was stored in the scalar processor 112_{1,2} is cyclically shifted 2 times and provided to the scalar processor 112_{31,2} and loaded into the column element register.

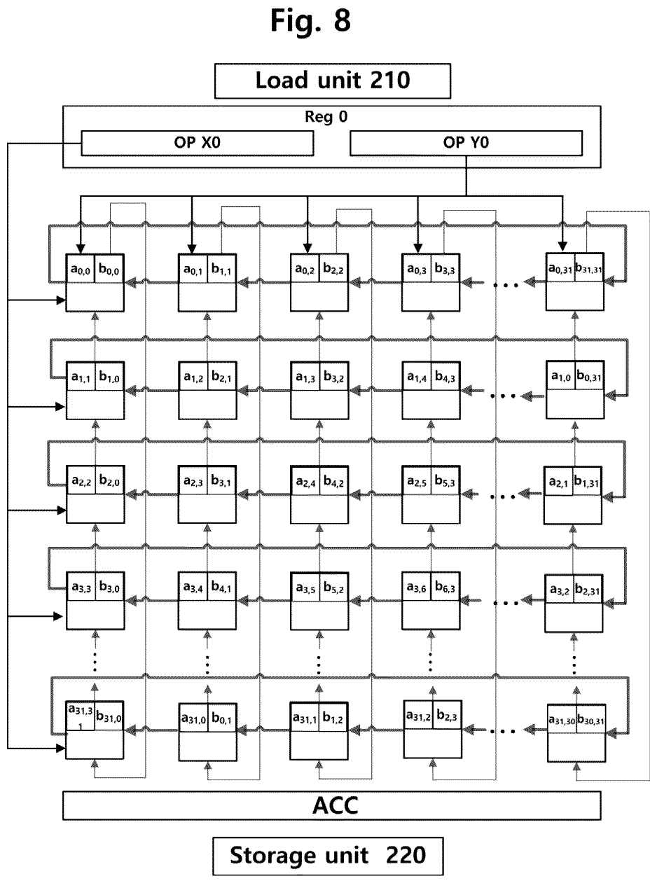

The state where cyclic shift is completed for each row and column in the 32×32 scalar processor array and row element values and column element values are loaded into the row element registers and column element registers of each scalar processor is illustrated in FIG. 8. In FIG. 8, the upper left of the illustrated scalar processors represents the row elements of the first operand stored in the row element register, the upper right represents the column elements of the second operand stored in the column element register, and the bottom represents the result values accumulated in the accumulation register. FIG. 8 illustrates a state where values are loaded into the row element registers and column element registers of each scalar processor and multiplication has not been performed.

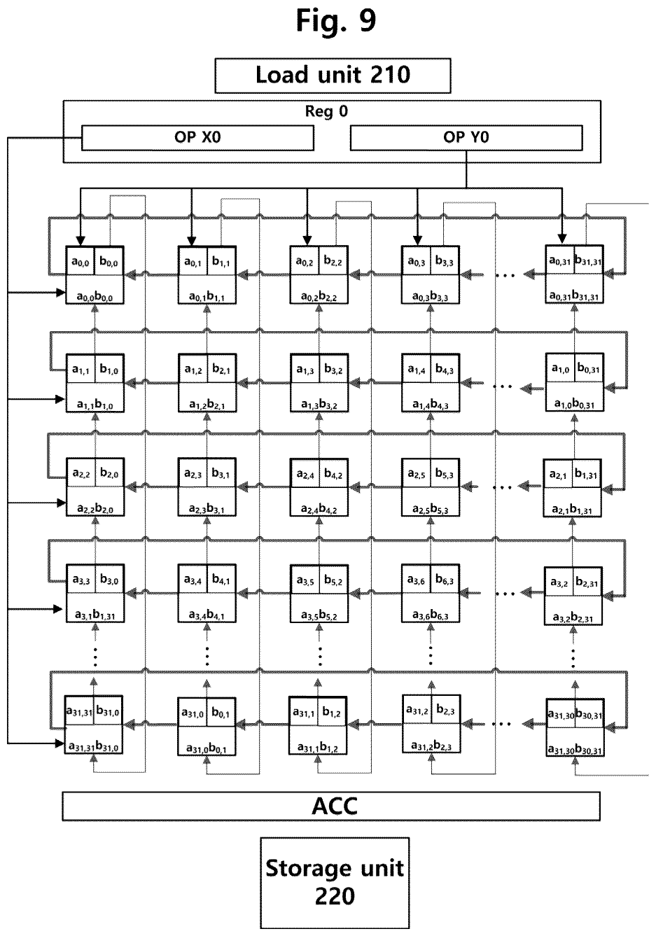

Each scalar processor multiplies the row element value and column element value loaded in the row element register and column element register to form a partial product, and accumulates and stores the partial products in values stored in their respective accumulation registers S200. FIG. 9 is a diagram illustrating a state where the result of multiplication performed with row element values and column element values loaded is stored in the accumulation register of each scalar processor. Referring to FIG. 9, the accumulation register included in each scalar processor multiplies the data stored in the row element register and column element register illustrated in FIG. 8 and stores it in the accumulation register.

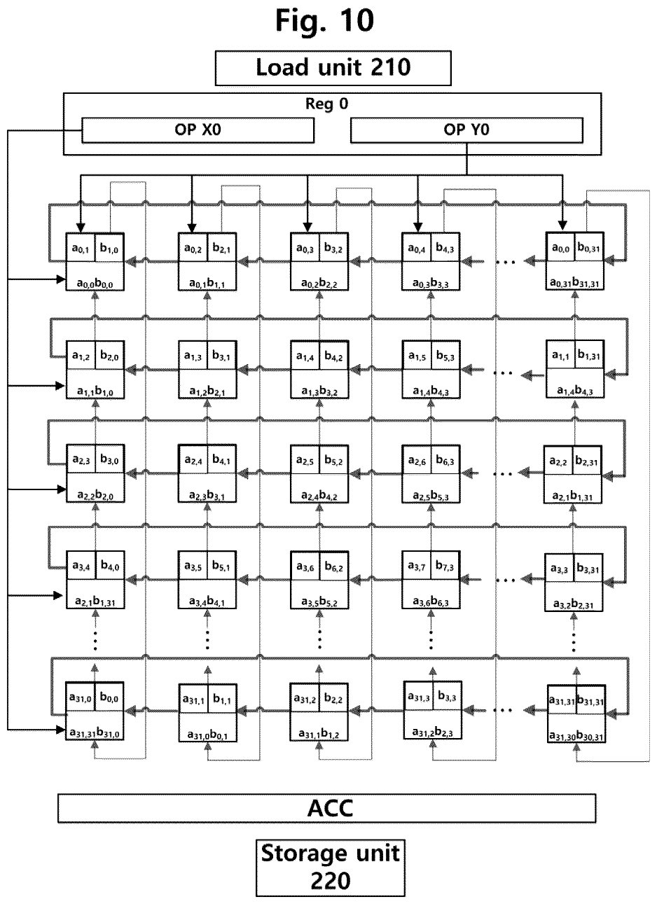

When multiplication and accumulation operations of row elements and column element values are completed in each scalar processor, the values stored in the row element registers are cyclically shifted in one direction, and the values stored in the other element registers are cyclically shifted in another direction S300. FIG. 10 illustrates a state where cyclic shift is performed after the multiplication operation illustrated in FIG. 9 is completed. As illustrated, each scalar processor shifts the value stored in the row element register in one direction and shifts the value stored in the column element register in another direction.

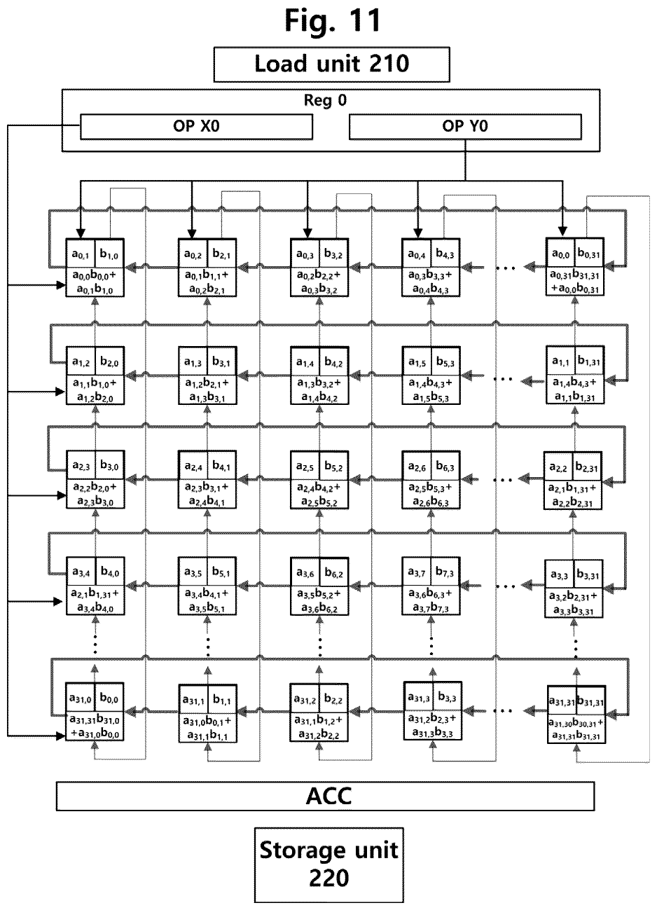

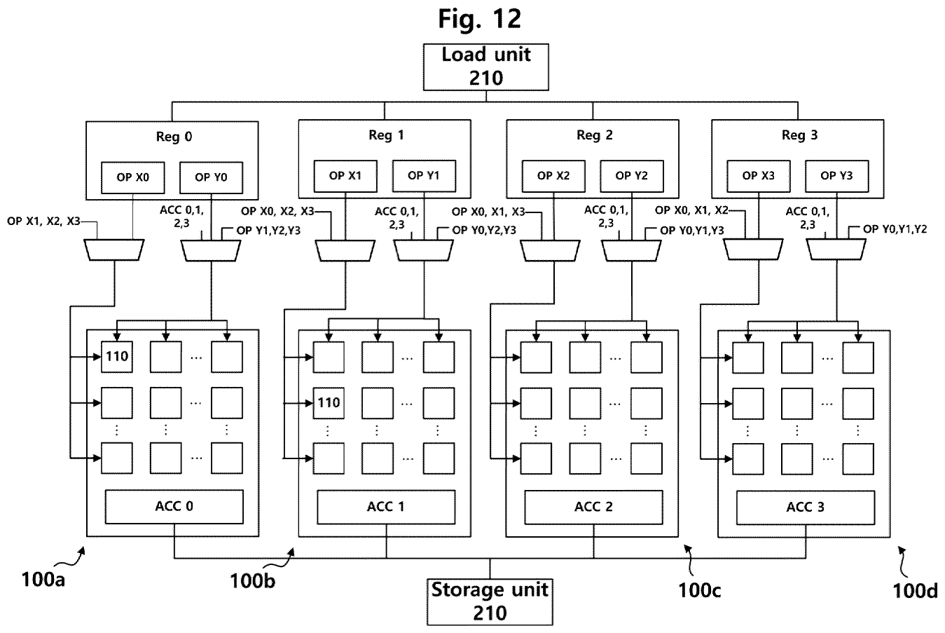

FIG. 11 is a diagram illustrating a state where multiplication operation results are accumulated after cyclic shift. Referring to FIG. 11, when the cyclic shift illustrated in FIG. 10 is completed, each operation unit included in the scalar processors multiplies the row element value and column element value cyclically shifted and loaded into the row element register and column element register to form partial products, and accumulates and stores them in partial products already stored in their respective accumulation registers. As the cyclic shift and accumulation process are repeated in this way, 32×32 matrix operations can be performed. In one embodiment, 32×32 matrix multiplication can obtain operation results through 31 cyclic shifts, 32 multiplications, and 31 partial product accumulations. The accumulation register included in each scalar processor provides operation results to the result register (ACC), and the storage unit 220 can store the results stored in the result register in the data cache within the internal memory 300.

In the above embodiment, the directions in which the first operand register (X0) and second operand register (Y0) provide the first operand and second operand to input to each scalar processor and the directions in which the provided operands are cyclically shifted are merely examples, and those skilled in the art can easily modify and implement from the description of the above embodiment.

The matrix multiplication operation results of operands A and B are provided to the accumulation register ACC included in the computation core, and the storage unit 220 can access the accumulation register ACC to obtain operation results and write them to the data cache 310 (see FIG. 2).

As described above, after each scalar processor 112 completes operations, it shifts and outputs the provided first operand and second operand in the row and column directions of the array, respectively. Since the first operand and second operand are provided to scalar processors 112 adjacent in the row or column direction, there is no need to form lines connecting the load unit or registers providing operands with all scalar processors included in the array, resolving routing difficulties and providing advantages in terms of area.

The parameters used in today's large language models have sizes of several terabytes. Connecting wiring to input several terabytes of operands to each scalar processor is a challenging task. However, according to this embodiment, the advantage of reducing the difficulty of wiring connections is provided by providing operands to only one row and one column of the scalar processor array.

Referring again to FIG. 4, in one embodiment, when any one computation core 100a among the computation cores included in the processor 10 performs matrix operations, the scalar processors sequentially shift while reading element values of operands from the XO register that stores the first operand and Y0 register that stores the second operand included in the computation core 100a and perform operations.

In this process, the load unit 210 can read operands used for operations from the data cache 310 for subsequent operations to be performed by the computation core 100b and store them in the X1 register and/or Y1 register included in the computation core 100b. Operating in a pipeline manner like this can reduce the time for reading operands used for operations and writing them to registers, thereby improving computational efficiency. This can improve computational efficiency when the data width that the load unit 210 can read at once is limited but the number of bits of operands required for operations is large.

FIG. 9 is a diagram illustrating an embodiment of a computation core 100 included in the processor 10. Referring to FIG. 9, the computation cores 100a, 100b, 100c, 100d of this embodiment may each further include an X multiplexer (MUX) that selects any one of the first operands provided by the first operand registers (XO, X1, X2, X3) included in the plurality of computation cores and outputs to the scalar processors.

Also, the computation cores 100a, 100b, 100c, 100d may further include a Y multiplexer that outputs any one of the second operands output by the second operand registers (Y0, Y1, Y2, Y3) and matrix operation results output by the accumulation registers (ACC 0, ACC 1, ACC 2, ACC 3) included in the plurality of computation cores to the array of scalar processors.

From this, the computation core 100a can perform matrix operations using first operand registers X1, X2, or X3 not included in the computation core 100a. Furthermore, the advantage is provided that the computation core 100a can immediately perform matrix operation Cx(AxB) after performing matrix operation AxB.

That is, while the computation core 100a had to store the result of performing matrix operation AxB in register ACC 0, the storage unit 210 store it in the data cache 310, and then the load unit 210 read the value stored in the data cache 310 again, the advantage is provided that matrix operation Cx(AxB) can be immediately performed quickly by the Y register.

Although described with reference to embodiments shown in the drawings to help understand the present invention, these are embodiments for implementation and are merely exemplary, and those skilled in the art will understand that various modifications and equivalent other embodiments are possible therefrom. Therefore, the true technical protection scope of the present invention should be determined by the appended claims.

What is claimed is:

1. A processor for performing matrix operations, the processor comprising:
a plurality of computation cores, wherein each of the computation cores comprises:
a scalar processor array that performs the matrix operations;
an X register that stores and provides a first operand of the matrix operations, a Y register that stores and provides a second operand of the matrix operations, and a result register that stores matrix operation results,
wherein the first operand and the second operand are loaded to a plurality of scalar processors of the array to perform the matrix operations, and
the scalar processor array performs cyclic shift of the loaded first operand and the second operand in one direction and another direction of the array, respectively.

2. The processor of claim 1, wherein each of the scalar processors comprises:
an operation unit that performs one or more of addition, subtraction, multiplication, and MAC (multiply and accumulate) operations; and
a register that stores the first operand and a register that stores the second operand.

3. The processor of claim 1, wherein:
the X register stores a multiplicand matrix that is a target of the matrix operations and outputs row-wise to the scalar processors included in any one column of the scalar processor array; and
the Y operand register stores a multiplier matrix that is a target of the matrix operations and outputs column-wise to the scalar processors included in any one row of the scalar processor array.

4. The processor of claim 3, wherein the scalar processors:
cyclically shift the output first operand along one direction of the array to load to respective scalar processors; and
cyclically shift the output second operand along another direction of the array to load to respective scalar processors.

5. The processor of claim 4, wherein in the array:
the number of cyclic shifts performed by the scalar processors included in adjacent rows differs by one; and
the number of cyclic shifts performed by the scalar processors included in adjacent columns differs by one.

6. The processor of claim 1, wherein the scalar processors perform cyclic shift in one direction and another direction of the array after performing the matrix operations with the loaded first operand and the second operand.

7. The processor of claim 1, wherein: the X register provides the first operand to only any one column of the array; and the Y register provides the second operand to only any one row of the array.

8. The processor of claim 1, wherein when the plurality of scalar processors perform the matrix operations with the shifted first operand and the second operand, operands to be computed in another computation core among the plurality of computation cores are fetched.

9. The processor of claim 1, wherein each of the computation cores further comprises:
an X multiplexer (MUX) that selects any one of the first operands provided by X registers included in the plurality of computation cores and outputs to the processor X register; and
a Y multiplexer that outputs any one of the second operands provided by Y registers included in the plurality of computation cores and matrix operation results provided by accumulation registers included in the plurality of computation cores to the processor Y register.

10. The processor of claim 1, wherein the value stored in the result register is provided as any one of the first operand and the second operand to one or more of the plurality of computation cores.

11. An artificial intelligence computation accelerator, the accelerator comprising:
a tensor processor including k computation cores;
a high bandwidth memory;
an internal memory unit including a cache memory that stores data to be computed from the high bandwidth memory and an instruction cache that stores instructions for the tensor processor; and
a control unit that fetches data and instructions from the internal memory and provides them to the tensor processor,
wherein the accelerator communicates data with the high bandwidth memory through a designated pseudo channel.

12. The accelerator of claim 11, further comprising a bus structure that communicates with the high bandwidth memory and a plurality of the accelerators.

13. The accelerator of claim 11, wherein the accelerator: operates in a globally asynchronous locally synchronous manner; and is capable of local power gating and clock gating.

14. The accelerator of claim 11, wherein:
a plurality of the accelerators are included in one neural processing unit (NPU) die; and
k neural processing units and j high bandwidth memory packages are bonded to an interposer to form a computation device, where k and j are natural numbers.

15. A matrix operation method performed in a scalar processor array including an X register that stores a first operand of matrix operations, a Y register that stores a second operand, and a plurality of scalar processors, the matrix operation method comprising:
an operand providing step in which the X register provides the first operand to the array and the Y register provides the second operand to the array;
an operation step in which the scalar processors included in the array perform the matrix operations with the provided first operand and second operand; and
a step in which each of the scalar processors included in the array cyclically shifts the provided first operand in one direction of the array and cyclically shifts the second operand in another direction of the array.

16. The matrix operation method of claim 15, wherein:
the first operand is a row of a multiplicand matrix and the second operand is a column of a multiplier matrix; and
the operand providing step is performed by the X register providing elements of the first operand row along any one column of the scalar processor array and the Y register outputting elements of the second operand column along any one row of the scalar processor array.

17. The matrix operation method of claim 16, further comprising:
a loading step performed after the operand providing step, in which the scalar processors cyclically shift the output first operand along rows of the array to load to respective scalar processors and cyclically shift the output second operand along columns of the array to load to respective scalar processors.

18. The matrix operation method of claim 15, wherein in the operand providing step:
the X register provides the first operand to only any one column of the array; and the Y register provides the second operand to only any one row of the array.

19. The matrix operation method of claim 15, further comprising, after the matrix operation method is completed, a step in which the matrix operation result is provided as operands to one or more of a plurality of computation cores.

20. The matrix operation method of claim 15, wherein when the matrix operation method is performed in a processor including a plurality of X registers, a plurality of Y registers, and a plurality of scalar processor arrays:
when performing the matrix operation method in a computation core of one scalar processor array, one or more of the following are performed:
a step of storing the first operand in the X register of another scalar processor array; and
a step of storing the second operand in the plurality of Y registers of the other scalar processor array.
